(19) United States
(12) Patent Application Publication
(10) Pub. No.: US 2008/0306814 A1
(43) Pub. Date: Dec. 11, 2008

(54) LOCALIZED ADVERTISEMENT SUBSTITUTION IN WEB-BASED CONTENT

(75) Inventor: MICHAEL J. HUDSON, DELRAY BEACH, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/758,326

(22) Filed: Jun. 5, 2007

(51) Int. Cl. G06Q 30/00; G06Q 99/00

(52) U.S. Cl. 705/14; 705/1

(57) ABSTRACT

The present invention discloses a system and a method of intermediate network nodes that substitute local content for detected advertisements before serving Web pages to Web clients. In the invention, served content provided by a remotely located Web server directed towards a remotely located Web browser can be detected by the network node that performs the substitution. The served content can include Web content related to a Web site and advertisement content. A portion of the served content representing advertisement content can be determined. The determined advertisement content can be replaced with substitute content. The Web content and the substitute content can be delivered to the Web browser.

### BACKGROUND

1. Field of the Invention

The present invention relates to the field of Web-based advertisement and, more specifically, to advertisement substitution in Web-based content.

2. Description of the Related Art

Advertisements placed on Web pages have become a major driving force on the Internet. Advertisers, Web content providers, and advertisement agencies involved in Web-based advertisement benefit directly from the advertisements. Advertisers receive heightened market awareness for their products. Advertisement agencies receive pecuniary rewards from the advertisers. Web content providers sell space on their Web sites to the advertisement agencies and thus receive a financial reward. However, Internet Service Providers (ISP), corporate networks, and end-users are often negatively impacted by Web-based advertisements, yet receive no benefit.

ISPs and corporate networks are network providers positioned between Web content providers and Web users. Web advertisements consume assets (i.e., storage space, bandwidth) of these network providers which increases network provider infrastructure costs. End-users often experience delays induced by advertisements which often do not interest the end-user. Additionally, advertisements can contain malicious payloads that virulently impact private networks and end-users to the detriment of the end users and network providers.

Historically, Web-based advertising follows a structure as illustrated by FIG. 1 (Prior Art). FIG. 1 shows a system 100 in which a Web server 130 serves a set of Web pages to requesting clients 110. Each served Web page can include Web content 160 and one or more advertisements 162. The Web content 160 can be provided by a content server 150 and the advertisements 162 can be provided by an advertisement server 140. The network provider 120 is a communication intermediary situated between the client 110 and the Web server 130.

### SUMMARY OF THE INVENTION

The present invention discloses a solution for advertisement substitution in Web-based content. Advertisement substitution in Web-based content can offer significant advantages for Internet Service Providers (ISPs), network providers, and end-users. In the solution, localized advertisement servers can be associated with ISPs and other network providers. ISPs and network providers can offer services which can allow advertisers to purchase substitute advertisements targeted to certain geographical regions and demographics. By using localized substitution in advertisements, network providers can control advertisement content and filter out dangerous or un-trusted advertisements. End-users can benefit from being targeted by specialized advertisements about products and services that can be geographically local and potentially useful.

The present invention can be implemented in accordance with numerous aspects consistent with the material presented herein. For example, one aspect of the present invention can include a method of delivering Web content that includes a step of detecting served content provided by a remotely located Web server directed towards a remotely located Web browser. The served content can include Web content related to a Web site and advertisement content. A portion of the served content representing advertisement content can be determined. The determined advertisement content can be replaced with substitute content. The Web content and the substitute content can be delivered to the Web browser.

Another aspect of the present invention can include a system for substituting Web-based content that includes a network node. The network node can be an intermediate node positioned in a communication path between a Web browser and a Web server. The network node can include a substitution engine configured to detect advertisement content directed towards the Web browser and further configured to replace detected advertisement content with substitute content. The substitute content can include different advertisement content, such as local advertisements.

Still another aspect of the present invention can include a substitution engine that comprises a set of programmatic instructions stored in a machine readable medium and executable by a machine. The machine can be geographically located remotely from a Web server and a Web client which receive a set of Web pages served by the Web server. The substitution engine can detect advertisements contained in the Web pages and can determine a height and a width of a Web page area corresponding to an area in which the detected advertisements are to be presented. The substitution engine can then determine substitute content having approximately the same height and width as the Web page area. The detected advertisements can be replaced with the determined substitute content before the Web pages are delivered to the Web client.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 (prior art) is a schematic diagram of a conventional system in which advertising content is conveyed to clients along with desired Web content.

FIG. 2 is a schematic diagram illustrating a system for advertisement substitution in Web-based content in accordance with the embodiment of inventive arrangements disclosed herein.

FIG. 3 is a schematic diagram illustrating a system for advertisement substitution in Web-based content in accordance with the embodiment of inventive arrangements disclosed herein.

FIG. 4 is a scenario illustrating a system for advertising substitution in Web-based content in accordance with the embodiment of inventive arrangements disclosed herein.

FIG. 5 is a flow chart of a method for replacing advertisements in served Web pages in accordance with an embodiment of the inventive arrangements disclosed herein.

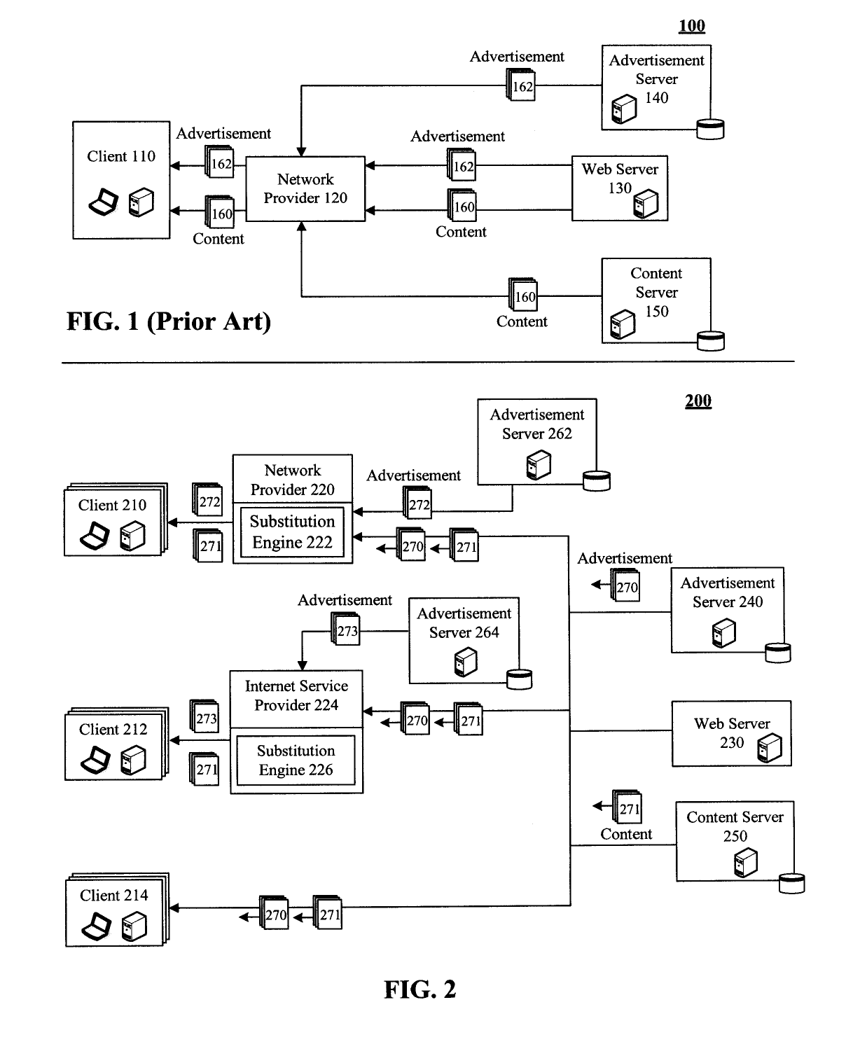

### DETAILED DESCRIPTION OF THE INVENTION

FIG. 2 is a schematic diagram illustrating a system 200 for advertisement substitution in Web-based content in accordance with the embodiment of inventive arrangements disclosed herein. The advertisement substitutions can be conducted by a substitution engine 222, 226, which replaces a received advertisement 270 with a different, locally served advertisement 272, 273. The substituted advertisements 272, 273 can be served in a Web page which contains Web content 271 that is conveyed from a Web server 230 to Web clients 210-214 in an unmodified form. The substituted advertisement content 272, 273 can be positioned in a Web page region equivalently positioned and sized as the originally served advertisement 270.

The substitution engine 222, 226 can be included in a network node (e.g., network element 220, 224) that is positioned between a client 210-214 and a Web server 230. The network node can be a network provider 220 such as a private or corporate network. The network node can also be an Internet Service Provider 224 which permits a client 212 to connect to the Internet. The substitution can be transparent to receiving clients 210-214. In one embodiment, the substituted content 272, 273 can be provided by a local advertisement server 262, 264. Advertisers (262, 264) can financially reward the network provider 220 and/or ISP 224 for delivering advertisement 272 and/or 273 to the clients 210-212.

In one embodiment, the Web server 230 can directly serve Web pages that contain content 271 and advertisement 270. In another embodiment, the Web server 230 can serve Web pages containing content provided by the advertisement server 240 and the content server 250. Further, the advertisement server 240 and/or the content server 250 can themselves be Web servers, each providing Uniform Resource Locator (URL) specified content. The Web pages served by server 230 can include links to the URLs of content from the advertisement server 240 and/or content server 250.

In one configuration, advertisement URLs can be maintained in a known list of advertiser specific URLs. For example, advertiser URLs can include “http://ad*.host.com, http://known.ad.provider.com/*” and the like. This list of advertiser URLs can be used by the substitution engines 222, 226 to detect advertisements contained in received Web pages. Removing these advertiser links from served Web pages results in a net bandwidth savings by the provider 220, 224 since bandwidth expended for advertisement delivery between the advertisement server 240 and the provider 220, 224 is saved.

In system 200, advertisements 270-273 can include markup specified content able to be rendered by a browser of client 210-214. The advertisements 270-273 can represent paid promotion of goods and/or services by an identified sponsor. Advertisements 270-273 can also include unpaid content. For example, content providers 250 who fail to sell all available screen real estate dedicated to advertisers often serve placeholders in lieu of advertising, where the place holders often advertise a service or product of the content provider 250. In another example, providers 220-224 can provide messages to clients 210-212 within the substituted content 272, 273 instead of providing local advertisements. Each advertisement 270-273 can include a combination of text, graphics, video, and/or audio renderable by a browser. Advertisements 270-273 can include dedicated regions of a Web page, Web-based banner advertisements, pop-up advertisements, pop-under advertisements and the like.

Web content 271 can include any digitally encoded data transmitted across a network from a server 230, 250 to a client 210-214. The Web content 271 can be content associated with Web pages of a Web site. Web content 271 can be any combination of text, graphics, video, and audio renderable by a browser. Web content can be encoded using programmatic instructions written in any markup language, such as a hypertext markup language (HTML), an extensible markup language (XML), a voice markup language (VoiceXML), and the like.

Clients 210-214 can be any computing device able to receive and render served Web pages, which includes Web content 271 and advertisements 270, 272, 273. Clients 210-214 can each include a desktop computer, a laptop computer, a mobile phone, a personal digital assistant (PDA), an entertainment system, a media player, and the like.

The components of system 200 can be communicatively linked to each other using a network (not shown). The network can include any hardware/software/and firmware necessary to convey digital content encoded within carrier waves. Content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

The Web content 271 and advertisements 270, 272, 273 as well as other information used by the various computing devices shown in system 200, can be stored in a series of data stores to which the computing devices have access. The data stores can be physically implemented within any type of hardware including, but not limited to, a magnetic disk, an optical disk, a semiconductor memory, a digitally encoded plastic memory, a holographic memory, or any other recording medium. Each of the data stores can be stand-alone storage units as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

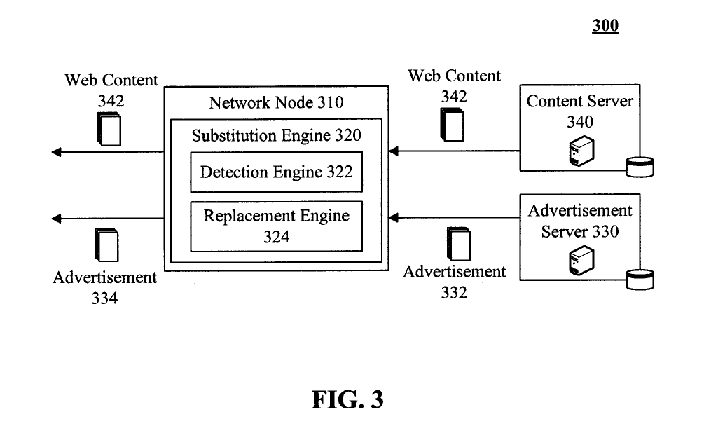

FIG. 3 is a schematic diagram illustrating a system 300 for advertising substitution in Web-based content in accordance with the embodiment of inventive arrangements disclosed herein. System 300 can be performed in the context of system 200. In system 300, a network node 310 can receive Web content 342 and an advertisement 332, can replace the advertisement 332 with a replacement advertisement 334, and can deliver the Web content 342 unchanged. The Web content 342 and advertisements 332, 334 can be components of a Web page.

The network node 310 can be any computing device (e.g. server, router, switch, etc.) capable of routing, switching and managing network data. The network node 310 can include of a substitution engine 320 which utilizes a detection engine 322 and a replacement engine 324 to detect and replace advertisement 332 with advertisement 334.

Detection engine 322 can include a set of programmatic instructions for searching and identifying elements, such as advertisements, contained in Web pages. Detection engine 322 can include a set of programmatic rules configured by an administrative user to identify particular elements in Web content. In one embodiment, detection engine 322 can function similar to a regular expression engine, matching patterns in Web content against pre-determined patterns accessible by detection engine 322. In another embodiment, URL matching can occur, wherein a URL acting as a placeholder can be identified and then replaced by a functioning URL. For example, a detection engine can identify http://www.host.com/*.jpg?THIS_IS_A_PLACEHOLDER as a placeholder URL and notify the replacement engine to replace it with a URL that presents an advertisement.

Replacement engine 324 can be a set of programmatic instructions for retrieving replacement advertisement 334 from a repository and replacing an original advertisement 332 with it. Replacement engine 324 can include a user administrate set of programmatic rules for selecting which of many possible advertisements are to be used as the replacement advertisement 334. The replacement engine 324 can record replacements which can be used for accounting purposes to ensure that the network node 310 owner is compensated for providing advertisements 334 to users. The replacement engine 324 can also re-size one or more advertisements 334 to fit a space previously occupied by advertisement 332.

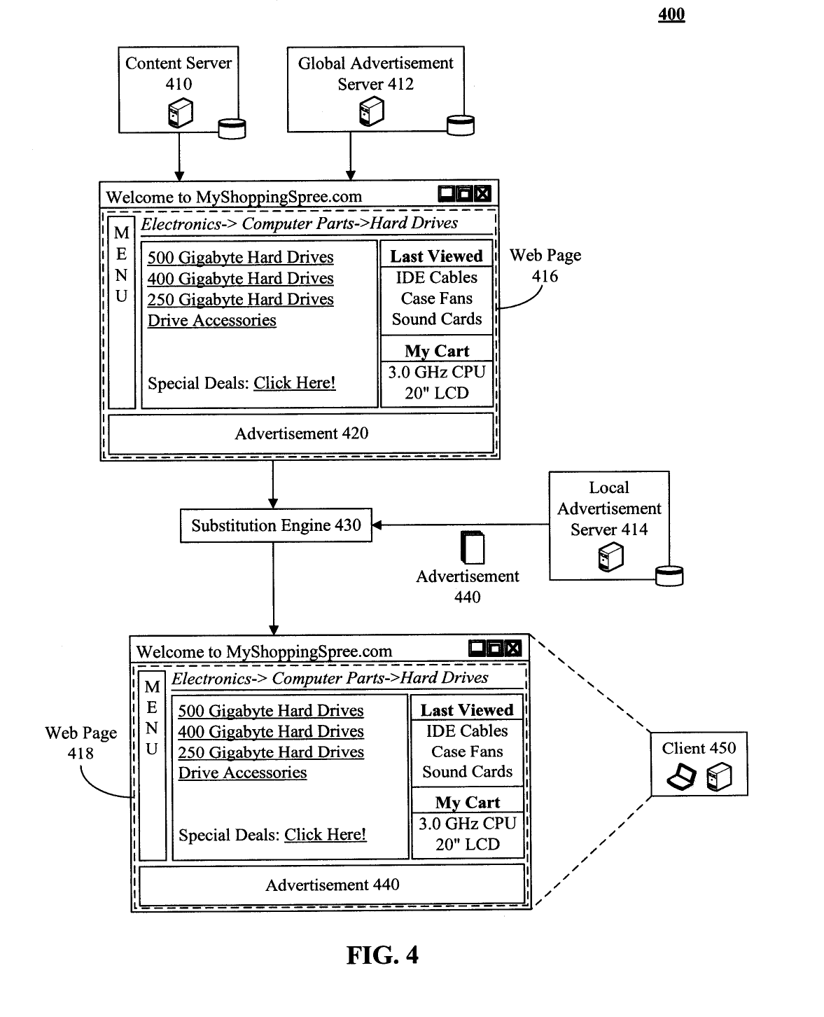

FIG. 4 is a scenario 400 illustrating a system for advertising substitution in Web-based content in accordance with the embodiment of inventive arrangements disclosed herein. Scenario 400 can be performed in the context of system 200. In scenario 400, a client 450 viewing a Web page 418 can be presented with an advertisement 440.

In scenario 400, the client 450 can request a Web page 416 from a Web server. The requested page 416 can include Web content from a content server 410 and an advertisement 420 from a global advertisement server 412. A substitution engine 430 can process Web page 416. During the processing, the substitution engine 430 can identity advertisement 420 and can request a replacement advertisement 440 from local advertisement server 414.

Local advertisement server 414 can respond to the request by transmitting advertisement 440 to substitution engine 430. Substitution engine 430 can replace advertisement 420 with advertisement 440. Web page 418 including the replaced advertisement 440 can be delivered to client 450.

In one arrangement, more than one replacement advertisement can be randomly selected by server 414 or engine 430. In another arrangement, a set of programmatic rules can be used to choose a best-fit replacement advertisement based on a size of the advertisement 420. Further, a single original advertisement 420 can be replaced by multiple substitute advertisements that together are approximately the size of advertisement 420. Additionally, multiple original advertisements can be replaced by a single replacement advertisement 440 that is approximately the size of the multiple original advertisements.

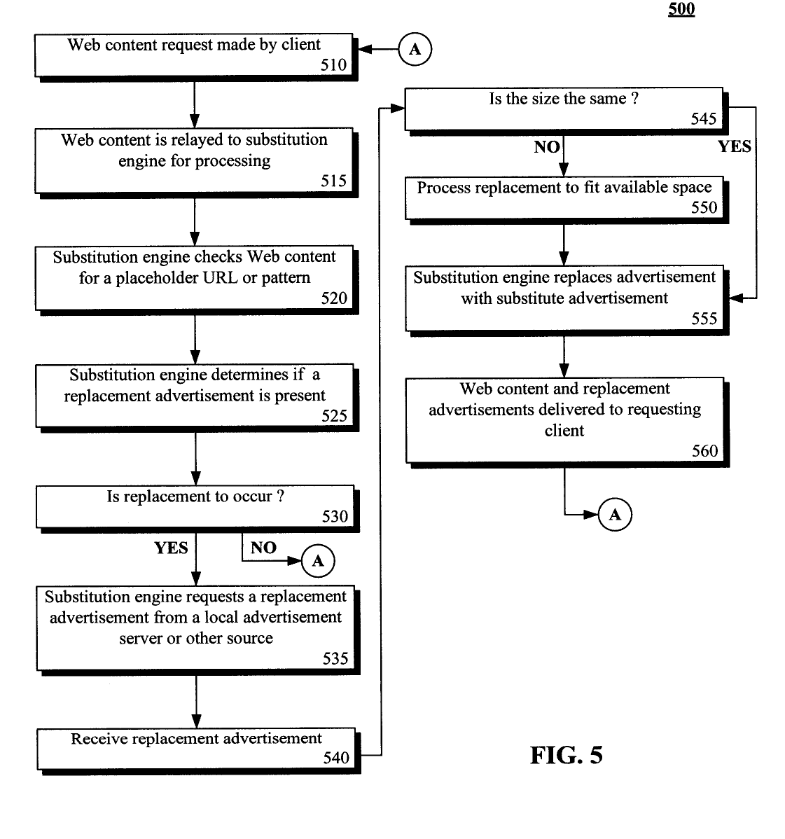

FIG. 5 is a flow chart of a method 500 for replacing advertisements in served Web pages in accordance with an embodiment of the inventive arrangements disclosed herein. The method 500 can be performed by a system 200 or similar system.

Method 500 can begin in step 510 where a client can request Web content. For example, a browser executing in a client can request Web content associated with a user entered domain name. In step 515, the Web content can be relayed to a substitution engine of a network node for processing. In step 520, the substitution engine can check the Web content for a placeholder URL or other pattern that indicates replaceable content. In step 525, the substitution engine can check the Web content for a replaceable advertisement. An optional set of rules can be used to determine whether identified optional content (e.g., an advertisement or placeholder) can be replaced. In step 530, a determination can be made based upon results of steps 520-525 as to whether a replacement is to occur. If not, the method can loop to step 510, where a different client request for Web content can be detected.

When content is to be replaced, the method can proceed from step 530 to step 535 where the substitution engine can request a replacement advertisement from a local advertisement server or other source. In step 540, the replacement advertisement can be received. In step 545, a size of the replacement advertisement can be compared against a size of the original advertisement. When the size is different, the replacement advertisement can be processed to adjust the size to suit the available space, as shown by step 550. In step 555, the substitution engine can replace the original advertisement with the new advertisement. In step 560, a Web page including the replacement advertisement can be delivered to the requesting client. The method can repeat whenever another Web content request is made by the client, as indicated by the looping from step 560 to step 510.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of delivering Web content comprising:
detecting served content provided by a remotely located Web server directed towards a remotely located Web browser, said served content comprising Web content related to a Web site and advertisement content;
determining a portion of the served content that represents advertisement content;
replacing the advertisement content with substitute content; and
delivering the Web content and the substitute content to the Web browser.

2. The method of claim 1, wherein the detecting, determining, replacing, and delivering steps are automatically performed by a private network which links a client in which the Web browser is executing to an Internet.

3. The method of claim 1, wherein the detecting, determining, replacing, and delivering steps are automatically performed by an Internet Service Provider (ISP).

4. The method of claim 1, wherein the advertisement content is associated with a region of a Web page renderable by the Web browser, wherein the substitute content corresponds to the same region of the Web page.

5. The method of claim 1, wherein the substitute content comprises different advertisement content.

6. The method of claim 5, wherein the detecting, determining, replacing, and delivering steps are automatically performed by a network provider which is financially compensated for delivering the different advertisement content.

7. The method of claim 5, wherein the different advertisement content is a local advertisement delivered to each Web Browser in a geographic region that is serviced by a server performing the detecting, determining, replacing, and delivering steps.

8. The method of claim 1, wherein the determining step further comprises:
comparing a uniform resource locator (URL) for a section of the served content against a set of URLs known to be associated with advertisements, wherein a matching of the compared URLs represents a positive determination of advertising content.

9. The method of claim 8, further comprising:
determining a height and width associated with the advertising content; and
at least one of processing and selecting the substitute content so that the substitute content has an approximately equivalent height and width of the advertising content.

10. The method of claim 1, wherein the advertisement content that is replaced with the substitute content is a placeholder for content provided by a content provider, wherein advertisement content provided by advertisers is distinguished front the placeholder content and handled differently.

11. The method of claim 1, further comprising:
recording an entry in a database that indicates a delivery of the substitute content; and
sending an invoice to an entity associated with the substitute content for payment from the entity for the delivery of the substitute content.

12. The method of claim 1, wherein said steps of claim 1 are steps performed automatically by at least one machine in accordance with at least one computer program having a plurality of code sections that are executable by the at least one machine, said at least one computer program being stored in a machine readable medium.

13. A system for substituting in Web-based content comprising:
a network node that is an intermediate node positioned in a communication path between a Web browser and a Web server, said network node including a substitution engine configured to detect advertisement content directed towards the Web browser and further configured to replace detected advertisement content with substitute content.

14. The system of claim 13, wherein the substitute content comprises different advertisement content.

15. The system of claim 14, wherein the network node is a network provider which is financially compensated for delivering the different advertisement content.

16. The system of claim 13, wherein the network node is an Internet Service Provider (ISP) node.

17. A substitution engine comprising:
a set of programmatic instructions stored in a machine readable medium and executable by a machine, said machine being geographically located remotely from a Web server and a Web client that receives a set of Web pages served by the Web server, wherein the substitution engine is configured to detect advertisements contained in the Web pages, to determine a height and a width of a Web page area corresponding to an area in which the detected advertisements are to be presented, to determine substitute content having approximately the same height and width as the Web page area, and to replace the detected advertisements with the determined substitute content before the Web pages are delivered to the Web client.

18. The substitution engine of claim 17 further comprising:
a list of a set of URLs known to be associated with advertisement servers, said set of programmatic instructions being further configured to detect an occurrence of URLs matching a URL in the set, wherein each occurrence is identified as a detected advertisement.

19. The substitution engine of claim 17, wherein said set of programmatic instructions further identify a plurality of local advertisements, wherein the substitute content is a selected one of the local advertisements.

20. The substitution engine of claim 19, wherein the substitute content is contained in a network provider server, wherein the substitute content comprises different advertisements, wherein said set of programmatic instructions record each time a Web page including substitute content is delivered, and wherein records of substitute content delivery are used to financially compensate an entity associated with the network provider server.
